(19) United States
(12) Patent Application Publication
(10) Pub. No.: US 2012/0051345 A1
(43) Pub. Date: Mar. 1, 2012

(54) EFFICIENT DUAL BSS SCHEDULING

(75) Inventors: Ramanuja VEDANTHAM, Allen, TX (US); John W. THOMAS, Arlington, TX (US); Xiaolin LU, Plano, TX (US); Ariton E. XHAFA, Plano, TX (US); Yanjun SUN, Richardson, TX (US)

(73) Assignee: TEXAS INSTRUMENTS INCORPORATED, Dallas, TX (US)

(21) Appl. No.: 13/166,428

(22) Filed: Jun. 22, 2011

Related U.S. Application Data
(60) Provisional application No. 61/379,127, filed on Sep. 1, 2010.

(51) Int. Cl. H04W 4/00

(52) U.S. Cl. 370/338

(57) ABSTRACT

An integrated circuit includes logic configured to adjust an original service time of a first Wi-Fi Basic Service Set connection (“BSS”), out of a plurality of BSSs configured to be associated with a communication device, to an adjusted service time based on a time until beacon transmission or reception in any of the plurality of BSSs. At least one of the plurality of BSSs can support a peer-to-peer connection.

### CROSS-REFERENCE TO RELATED APPLICATION

The present application claims priority to U.S. Provisional Patent Application No. 61/379,127, filed on Sep. 1, 2010 (Attorney Docket No. TI-69894PS); which is hereby incorporated herein by reference.

### BACKGROUND

There are more than 1 billion Wi-Fi devices in use today. Wi-Fi is widely available in homes, Wi-Fi hotspots, enterprise environments, and is found in many types of devices. The Wi-Fi Alliance has more than 350 member companies, and has completed numerous product certifications. As such, any efficiencies in Wi-Fi communication will have a wide impact.

### SUMMARY

Embodiments for efficient dual basic service set scheduling are described herein. In at least some disclosed embodiments, an integrated circuit includes logic configured to adjust an original service time of a first Wi-Fi Basic Service Set connection (“BSS”), out of a plurality of BSSs configured to be associated with a communication device, to an adjusted service time based on a time until beacon transmission or reception in any of the plurality of BSSs. At least one of the plurality of BSSs can support a peer-to-peer connection.

In other disclosed embodiments, a method includes adjusting an original service time of a first Wi-Fi Basic Service Set connection (“BSS”), out of a plurality of BSSs configured to be associated with a communication device, to an adjusted service time based on a time until beacon transmission or reception in any of the plurality of BSSs. At least one of the plurality of BSSs is supportive of a peer-to-peer connection

In yet other disclosed embodiments, a non-transitory machine-readable storage medium includes executable instructions that, when executed, cause one or more processors to adjust an original service time of a first Wi-Fi Basic Service Set connection (“BSS”), out of a plurality of BSSs configured to be associated with a communication device, to an adjusted service time based on a time until beacon transmission or reception in any of the plurality of BSSs. At least one of the plurality of BSSs is supportive of a peer-to-peer connection.

These and other features and advantages will be more clearly understood from the following detailed description taken in conjunction with the accompanying drawings and claims.

### BRIEF DESCRIPTION OF THE DRAWINGS

For a more complete understanding of the present disclosure, reference is now made to the accompanying drawings and detailed description, wherein like reference numerals represent like parts:

FIG. 1 illustrates an example of specific devices in a dual BSS configuration in accordance with at least some illustrative embodiments;

FIG. 2 illustrates another example of a dual BSS configuration in accordance with at least some illustrative embodiments;

FIG. 3 illustrates a dual BSS device in accordance with at least some illustrative embodiments;

FIG. 4 illustrates BSS service time allocation in accordance with at least some illustrative embodiments;

FIG. 5 illustrates dual BSS scheduling in accordance with at least some illustrative embodiments;

FIG. 6 illustrates a method for dual BSS scheduling in accordance with at least some illustrative embodiments; and

FIG. 7 illustrates a particular machine suitable for implementing one or more embodiments described herein.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or a direct electrical connection. Thus, if a first device couples to a second device, that connection may be through a direct electrical connection, or through an indirect electrical connection via other devices and connections.

The terms “computer readable medium” or “machine readable medium” as referred to herein relates to non-transitory media capable of maintaining expressions that are perceivable by one or more machines. For example, a computer readable medium may comprise one or more storage devices for storing computer readable instructions or data. Such storage devices may comprise storage media such as, for example, optical, magnetic or semiconductor storage media. However, this is merely an example of a computer readable medium, and embodiments are not limited in this respect.

The term “logic” as referred to herein relates to structure for performing one or more logical operations. For example, logic may comprise circuitry that provides one or more output signals based upon one or more input signals. Such circuitry may comprise a finite state machine, which receives a digital input and provides a digital output, or circuitry, which provides one or more analog output signals in response to one or more analog input signals. Such circuitry may be provided in an application specific integrated circuit (“ASIC”) or field programmable gate array (“FPGA”). Also, logic may comprise machine-readable instructions stored in a memory in combination with processing circuitry to execute such machine-readable instructions. However, these are merely examples of structures that may provide logic, and embodiments are not limited in this respect.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Wi-Fi Direct devices connect in a way that makes it convenient for users to print, share, and display files. Wi-Fi Direct devices connect directly to one another without access to traditional network infrastructure such as stations (“STAs”) or access points (“APs”). As such, mobile phones, cameras, printers, computers, gaming devices, and the like can connect to each other directly to transfer content and share applications without network infrastructure. Devices can make a one-to-one connection, or a group of several devices can connect simultaneously. The devices can connect for a single exchange, or the devices can retain the memory of the connection and link together each time the devices are in proximity.

Wi-Fi Direct is also known as Wi-Fi Peer-to-Peer (“P2P”), and the Wi-Fi Peer to Peer Technical Specification, Version 1.0.14, Wi-Fi Alliance Technical Committee, P2P Task Group, 2010 is incorporated by reference as if fully reproduced herein. A Wi-Fi Direct device is capable of peer-to-peer connections as well as infrastructure connections. Wi-Fi Direct devices connect by forming Groups in a one-to-one or one-to-many topology. A single Wi-Fi Direct device is in charge of the Group including controlling which devices are allowed to join the Group and when the Group is terminated. This Group Master will appear as an access point (“AP”) to legacy devices. The Group Master is not an AP, but it provides some of the services commonly provided by an AP. Examples include BSS functionality, Wi-Fi Protected Setup Internal Registrar functionality, and communication management between clients in the Group. Any Wi-Fi Direct device is capable of being Group Master, and is able to negotiate with other Wi-Fi Direct devices as to which device will be the Group Master. A Group may include both Wi-Fi Direct devices and legacy devices (i.e., Wi-Fi certified devices that are not compliant with the Wi-Fi Alliance Peer-to-Peer Specification).

Wi-Fi Direct devices also support discovery, power management, managed device mechanisms, and concurrent infrastructure connections. Device discovery scans for and identifies other Wi-Fi Direct devices in order to establish a connection. Users can select a discovered device for connection, and if the discovered device is not already part of a Group, a new Group is formed. If the discovered device is already part of a Group, the scanning Wi-Fi Direct device may attempt to join the existing Group. Wi-Fi protected setup obtains credentials and authenticates the scanning Wi-Fi Direct device.

Service discovery enables the advertisement of services supported by higher layer applications (e.g., Bonjour, UPnP, and Web Service Discovery) to Wi-Fi Direct devices. Service discovery can be performed at any time (e.g. even before a connection is formed) with any other discovered Wi-Fi Direct device. For example, if a user wishes to print a photo, the printing application can identify which Wi-Fi Direct devices provide printing services and can present a compatible list of options to the user. As such, a camera can query to determine if Wi-Fi Direct devices are printers.

After a Group is formed, a Wi-Fi Direct device may invite another Wi-Fi Direct device to join the Group. The invited device may decline, accept, or ignore the invitation. Groups may be re-invoked for additional sessions after initial formation, and invitations can also be used to request that a previously used persistent Group be reformed. For example, a laptop could create a persistent Group comprised of the laptop and a printer. Persistent Groups may be restarted without provisioning, thus eliminating the need to repeat tasks such as entering a Wi-Fi Protected Setup PIN. Similarly, Wi-Fi Direct devices can store other persistent Group information and credentials.

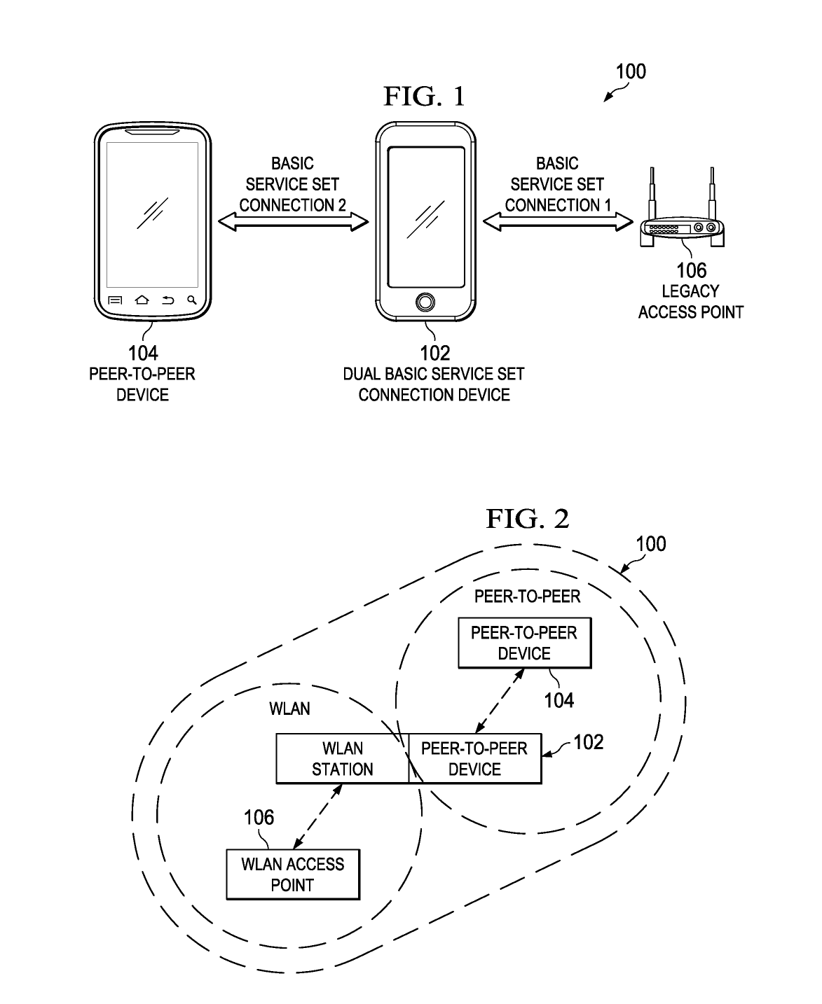

A Wi-Fi Direct Device that can be in a Group while maintaining a network infrastructure connection at the same time is a concurrent device or dual basic service set connection (“BSS”) device. A BSS is a set of stations and/or access points that have successfully synchronized using WLAN. Membership in a BSS does not imply that wireless communication with all other members of the BSS is possible. BSS may also refer to the channels, bands, etc. on which the devices communicate. For example, FIG. 1 illustrates a dual BSS device 102. The dual BSS device 102 has an established connection (BSS1) with a legacy AP 106 and another established connection (BSS2) with P2P device 104. As such, BSS2 supports a P2P connection and operates concurrently with BSS1. BSS1 is a TCP/FTP connection in at least one embodiment. The devices 102, 104, 106 and the BSSs make up the network 100. FIG. 2 illustrates that the network 100 can include two subnetworks. The P2P subnetwork includes P2P device 104, dual BSS device 102, and BSS2. The WLAN subnetwork includes legacy AP 106, dual BSS device 102, and BSS1. Concurrent connections may be supported by a single transceiver in the dual BSS device 102, and may support connections on different channels.

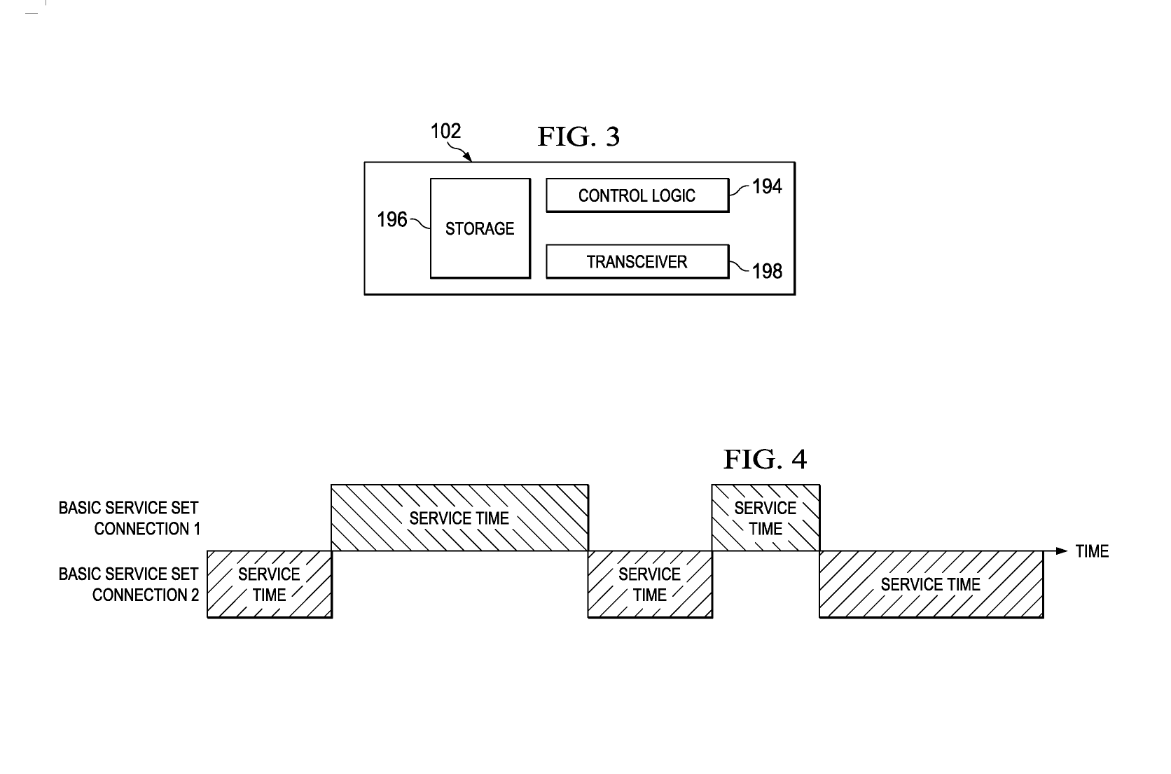

FIG. 3 illustrates the dual BSS device 102 in at least some embodiments. The device 102 includes non-transitory storage 196, a transceiver 198, and control logic 194. The control logic 194 comprises a processor or application specific integrated circuit (“ASIC”) in various embodiments. Any or all of the components may be coupled in at least some embodiments. The transceiver 198 may include an antenna and logic configure to process incoming and outgoing traffic. The storage 196 may include general or dedicated random access memory or non-volatile storage (e.g., read-only memory, flash storage, etc.). The control logic 194 can execute any action described herein. Specifically, instructions and software can be executed.

FIG. 4 illustrates service times in at least some embodiments. If the BSSs share the transceiver 198, then some dedicated time is allotted for each BSS to access the transceiver 198 to prevent both BSSs from accessing the wireless medium simultaneously. This dedicated time is referred to as the service time. A BSS within its assigned service time is an active BSS, while a BSS outside of its assigned service time is an inactive BSS. FIG. 4 illustrates that BSS1 and BSS2 alternate service times. However, it is inefficient for each service time to be the same length, especially if the service time is unneeded or not available when needed. The control logic 194 includes logic configured to adjust an original service time of a first BSS such as BSS1. The original service time is a service time that is predicted or scheduled to occur. If no service time is predicted or scheduled to occur, then adjusting the original service time means scheduling the current service time to accommodate predicted or scheduled packets on any BSS. Both BSS1 and BSS2 are associated with a communication device such as dual BSS device 102. At least one of the plurality of BSSs, such as BSS2, can support a peer-to-peer connection. As explained below, to increase efficiency the original service time is adjusted to an adjusted service time based on a time until a transmission or reception of a specific packet in any BSS.

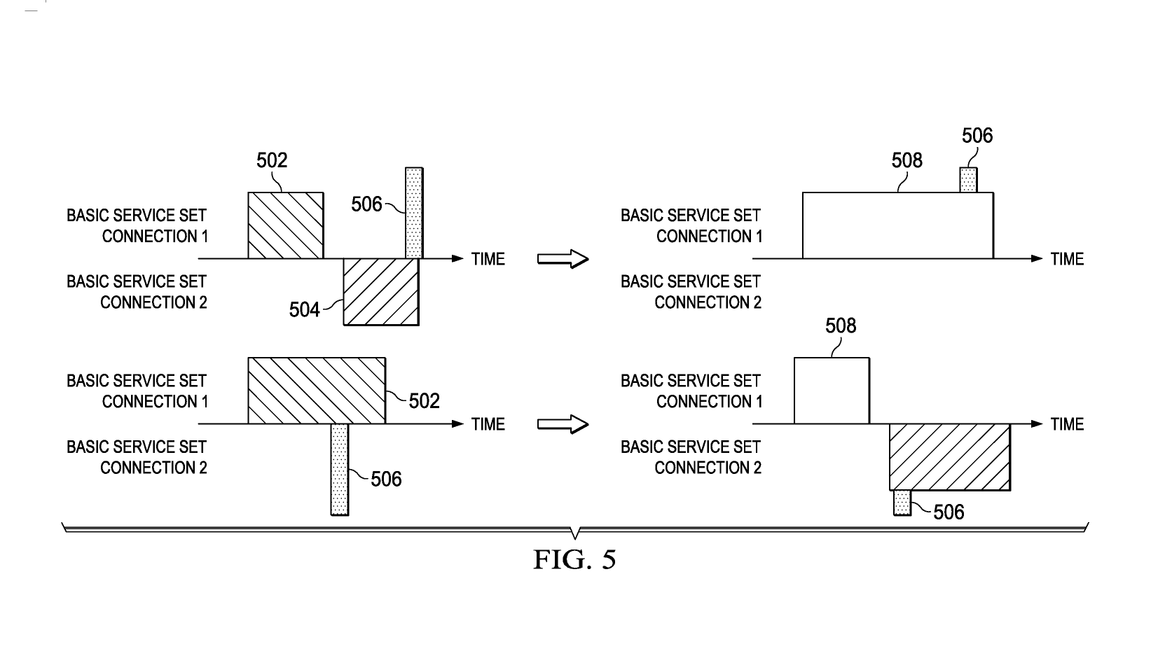

FIG. 5 illustrates steps to increase the efficiency of service times. Considering the top illustrated scenario, beacon 506 is scheduled or predicted to be received or transmitted on BSS1 outside of the service time 502 of BSS1. Specifically, the beacon 506 will be received or transmitted during the service time 504 of BSS2. A beacon 506 is an high-priority packet or frame in wireless communication because it is a management frame that triggers communication. While a beacon 506 is used in the example, the specific packet that causes adjustment in service times can be any type of packet or frame such as a management frame, administrative frame, and the like. Control logic 194 is configured to adjust the original service time 502 by increasing the original service time of the first BSS such that the beacon will be transmitted or received on the first BSS within the adjusted service time 508.

Considering the bottom illustrated scenario, if the beacon 506 will be transmitted or received on BSS2 within the original service time 502 for BSS1, the logic is configured to adjust the original service time 502 by decreasing the original service time for BSS1 such that the beacon will be transmitted or received outside of the adjusted service time 508. Preferably, the beacon will be transmitted or received during service time for BSS2. As illustrated in both examples, the service time for BSS1 is adjusted. However, in at least some embodiments, the service time for BSS2 will be adjusted. Furthermore, two BSSs have been shown as illustrative examples. In at least some embodiments, more than 2 BSSs make up the network 100.

Accommodation of beacons or high-priority frames is one factor among many that will adjust the service time in at least some embodiments. In at least one embodiment, the control logic 194 is configured to further adjust the original service time of BSS1 based on a difference between packet types, packet sizes, packet retransmissions, packet timestamps, acknowledgement counts, or received-frame sizes between different BSSs. As mentioned previously, some packets or frames have a higher priority than other packets or frames. This priority is quantified in at least one embodiment. For example, each packet is assigned an integer, a higher integer representing a higher priority. Traffic with a higher priority will have more of an impact in adjusting the service time to accommodate successful transmission of the high priority traffic. Packet sizes are also easily quantified via the number associated with their size. In some embodiments, large packets, such as packets associated with video traffic, will have more of an impact in adjusting the service time to accommodate successful transmission. In other embodiments, small packets will have more of an impact in adjusting the service time to accommodate successful transmission. Network administrators may adjust the impact according to network demands.

In at least one embodiment, packets that are retransmissions of previously transmitted packets will have more or less of an impact in adjusting the service time to accommodate successful transmission than packets being sent or received for the first time. In various embodiments, packets that are older or younger, as measured by timestamp, will have more or less of an impact in adjusting the service time to accommodate successful transmission according to network needs. Other factors include acknowledgement counts (i.e., the amount of acknowledgment packets received or transmitted per service time), the received frame-sizes per BSS (i.e., the sum of the sizes of received frames for each BSS service time), and a difference between data rates between BSS1 and BSS2. As mentioned previously, these factors can have a positive or negative impact on adjusting the service time to accommodate successful transmission as appropriate for the network 100. A configurable priority table is illustrated in Table 1. As illustrated, a beacon management packet has the highest priority. As such, the most accommodation will be made to successfully receive or transmit this packet in terms of scheduling service time. The first column of Table 1 quantifies priority. The second column lists the type of packet for a given priority. The third column lists details about the particular packet for a given type. AC_VO, AC_VI, AC_BE, and AC_BK are the four access categories in enhanced distributed channel access (“ECDA”). The fourth column of Table 1 denotes if a packet is a retransmission. The fifth column of Table 1 denotes how close a given packet is to the end of a service time or the delay bound. The “˜” symbol indicates very close such that an adjustment should be more likely to be made, “<” indicates somewhat close, and “<<” not close such that an adjustment should be less likely to be made. The table represents a configurable database that can be changed as needs dictate.

TABLE 1

| Packet | | | Re- | |
|---|---|---|---|---|
| Priority | Type | Details | TX | Packet Lifetime |
| 1 | Management | Beacon TX/RX | | |
| 2 | DB | Min./Max. BSS | | |
| | | Service Time | | |
| 3 | Management | Reassociation | | ~delay bound |
| | | request/response | | |
| 4 | Management | Association | | ~delay bound |
| | | request/response | | |
| 5 | Management | Authentication | | ~delay bound |
| | | request/response | | |
| 6 | Management | Probe Request/ | | ~delay bound |
| | | Response | | |
| 7 | Data | AC_VO | X | ~delay bound |
| 8 | Data | AC_VI | X | ~delay bound |
| 9 | Data | AC_BE | X | ~delay bound |
| 10 | Data | AC_BK | X | ~delay bound |
| 11 | Management | Reassociation | | <delay bound |
| | | request/response | | |
| 12 | Management | Association | | <delay bound |
| | | request/response | | |
| 13 | Management | Authentication | | <delay bound |
| | | request/response | | |
| 14 | Management | Probe Request/ | | <delay bound |
| | | Response | | |
| 15 | Management | Reassociation | | <<delay bound |
| | | request/response | | |
| 16 | Management | Association | | <<delay bound |
| | | request/response | | |
| 17 | Management | Authentication | | <<delay bound |
| | | request/response | | |
| 18 | Management | Probe Request/ | | <<delay bound |
| | | Response | | |
| 19 | Data | AC_VO | X | <delay bound |
| 20 | Data | AC_VI | X | <delay bound |
| 21 | Data | AC_BE | X | <delay bound |
| 22 | Data | AC_BK | X | <delay bound |
| 23 | Data | AC_VO | X | <<delay bound |
| 24 | Data | AC_VI | X | <<delay bound |
| 25 | Data | AC_BE | X | <<delay bound |
| 26 | Data | AC_BK | X | <<delay bound |
| 27 | Data | AC_VO | | ~delay bound |
| 28 | Data | AC_VI | | ~delay bound |
| 29 | Data | AC_VO | | <delay bound |
| 30 | Data | AC_VI | | <delay bound |
| 31 | Data | AC_BE | | ~delay bound |
| 32 | Data | AC_BK | | ~delay bound |
| 33 | Data | AC_VO | | <<delay bound |
| 34 | Data | AC_VI | | <<delay bound |
| 35 | Data | AC_BE | | <delay bound |
| 36 | Data | AC_BK | | <delay bound |
| 37 | Data | AC_BE | | <<delay bound |
| 38 | Data | AC_BK | | <<delay bound |

Additionally, thresholds may be implemented to ensure that one factor does not dominate and cause a BSS to starve. For example, a minimum BSS service time threshold and a maximum BSS service time threshold ensures a minimum quality of service for each BSS in at least one embodiment. Also, the switching overhead incurred as a result of switching between BSSs is considered as a threshold or factor in at least one embodiment.

The factors that adjust service time may be weighted and combined to change service times as appropriate. For example, the adjusted service time may be calculated using the following formula: Adjusted Service Time=(sum of packet sizes in queue/data rate of BSS1)+(buffer*number of packets in queue), where the buffer is the duration of time that accounts for the media access control (“MAC”) layer overhead caused by access delays and acknowledgements. Such a buffering time may be on the order of 150 microseconds. As such, Adjusted Service Time=((1500 bytes+1500 bytes+870 bytes)/24 Mbps)+(150 microseconds*3 packets.)=1.74 milliseconds. Applying a threshold of 3 milliseconds: adjusted service time=min (1.74 milliseconds, 3 milliseconds)=3 milliseconds.

Also, the factors may be tiered or weighted to provide additional guidance as to how much of an impact each factor will have on service time. In at least one embodiment, the logic is configured to adjust the original service time while the first BSS is active. In other embodiments, calculation and adjustment of the service time occur as necessary no matter which BSS is active. Another way to combine the factors is to adjust service times according to an algorithm. For example, first provision for beacon transmissions and receptions. Next, bound the service time between minimum and maximum service time values. Next, prioritize management frames, followed by voice frames, followed by video frames, followed by best effort frames, and followed by background traffic. Next, prioritize retransmissions higher than first transmissions or receptions.

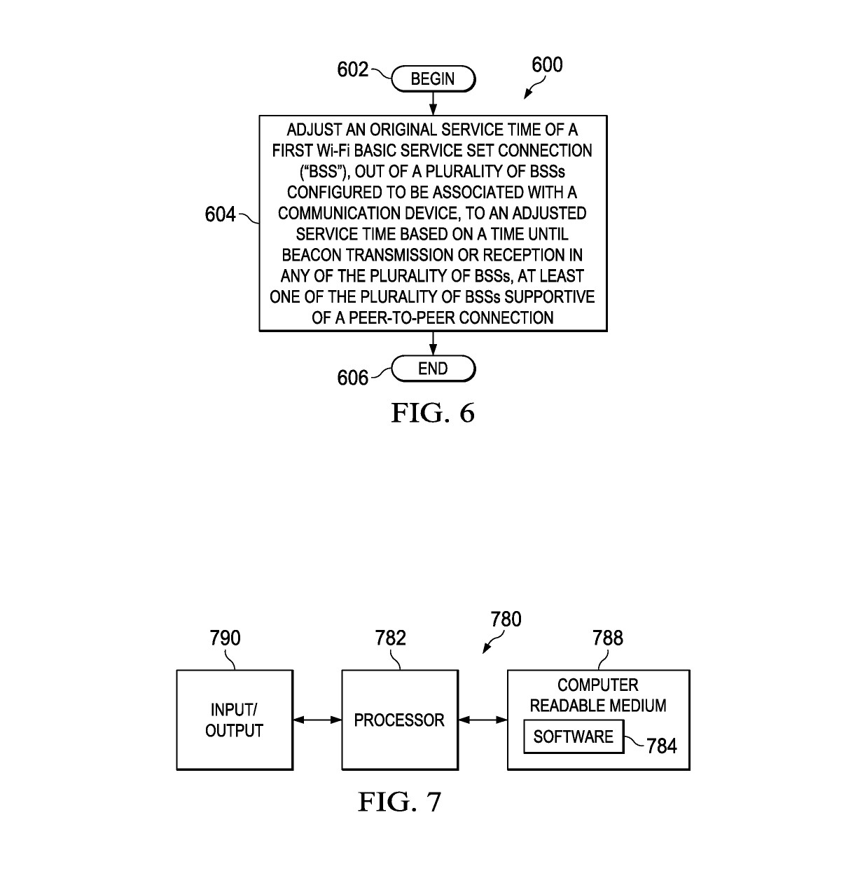

FIG. 6 illustrates a method 600 of efficient scheduling in a dual BSS device beginning at 602 and ending 606. At 604 an original service time of a first BSS, out of a plurality of BSSs configured to be associated with a communication device, is adjusted to an adjusted service time based on a time until beacon transmission or reception in any of the plurality of BSSs. At least one of the plurality of BSSs is supportive of a peer-to-peer connection. In at least one embodiment, if the beacon will be transmitted or received on the first BSS outside of the original service time, the original service time is adjusted by increasing the original service time of the first BSS such that the beacon will be transmitted or received on the first BSS within the adjusted service time. If the beacon will be transmitted or received on another BSS within the original service time, the original service time is adjusted by decreasing the original service time of the first BSS such that the beacon will be transmitted or received on the another BSS outside of the adjusted service time. Several factors may be considered together or separately in adjusting the original service time. Some factors include a difference between packet types, packet sizes, packet retransmissions, packet timestamps, acknowledgement counts, received-frame sizes between the first BSS and another BSS, a difference between data rates between the first BSS and another BSS, a minimum BSS service time threshold, a maximum BSS service time threshold, or switching overhead between the first BSS and another BSS. Additionally, a formula may be used to determine the adjustment. For example, the adjusted service time=((sum of sizes packets in queue)/data rate of first BSS)+((buffering time) (number of the packets in the queue)). In at least one embodiment, the original service time is adjusted while the first BSS is active.

The system described above may be implemented on any particular machine or computer with sufficient processing power, memory resources, and throughput capability to handle the necessary workload placed upon the computer. FIG. 7 illustrates a particular computer system 780 suitable for implementing one or more embodiments disclosed herein. The computer system 780 includes a processor 782 (which may be referred to as a central processor unit or CPU) that is in communication with memory devices including storage 788, and input/output (I/O) 790 devices. The processor may be implemented as one or more CPU chips or an ASIC. In various embodiments, the storage 788 comprises a computer-readable medium such as volatile memory (e.g., RAM), non-volatile storage (e.g., Flash memory, hard disk drive, CD ROM, etc.), or combinations thereof. The storage 788 comprises software 784 that is executed by the processor 782. One or more of the actions described herein are performed by the processor 782 during execution of the software 784.

Embodiments of the present invention may be implemented in the form of software, hardware, application logic, or a combination of software, hardware, and application logic. The software, application logic and/or hardware may reside on integrated circuit chips, modules, or memories. If desired, part of the software, hardware and/or application logic may reside on integrated circuit chips, part of the software, hardware and/or application logic may reside on modules, and part of the software, hardware and/or application logic may reside on memories. In one exemplary embodiment, the application logic, software or an instruction set is maintained on any one of various conventional non-transitory machine-readable media.

Processes and logic flows which are described in this specification can be performed by one or more programmable processors executing one or more computer programs to perform functions by operating on input data and generating output. Processes and logic flows can also be performed by special purpose logic circuitry, e.g., an FPGA (field programmable gate array) or an ASIC (application-specific integrated circuit). Apparatus or devices which are described in this specification can be implemented by a programmable processor, a computer, a system on a chip, or combinations of them, by operating on input date and generating output. Apparatus or devices can include special purpose logic circuitry, e.g., an FPGA or an ASIC. Apparatus or devices can also include, in addition to hardware, code that creates an execution environment for computer program, e.g., code that constitutes processor firmware, a protocol stack, a database management system, an operating system, a cross-platform runtime environment, e.g., a virtual machine, or a combination of one or more of them.

Generally, a processor will receive instructions and data from a read-only memory or a random access memory or both. The elements of a computer generally include a processor for performing or executing instructions, and one or more memory devices for storing instructions and data. Machine-readable media may include all forms of nonvolatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. A computer program (also known as, e.g., a program, software, software application, script, or code) can be written in any programming language, including compiled or interpreted languages, declarative or procedural languages, and it can be deployed in any form, including as a stand-alone program or as a module, component, subroutine, object, or other unit suitable for use in a computing environment. A computer program can be deployed to be executed on one computer or on multiple computers that are located at one single site or distributed across multiple sites and interconnected by a communication network.

Certain features that are described in the context of separate embodiments can also be combined and implemented as a single embodiment. Conversely, various features that are described in the context of a single embodiment can also be implemented in multiple embodiments separately or in any suitable subcombinations. Moreover, although features may be described as acting in certain combinations and even initially claimed as such, one or more features from a combination as described or a claimed combination can in certain cases be excluded from the combination, and the claimed combination may be directed to a subcombination or variation of a subcombination. Although various aspects of the invention are set out in the independent claims, other aspects of the invention comprise other combinations of features from the embodiments and/or from the dependent claims with the features of the independent claims, and not solely the combinations explicitly set out in the claims. Certain functions that are described in this specification may be performed in a different order and/or concurrently with each other. Furthermore, if desired, one or more of the above-described functions may be optional or may be combined.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications. Additionally, audio or visual alerts may be triggered upon successful completion of any action described herein, upon unsuccessful actions described herein, and upon errors.

What is claimed is:

1. An integrated circuit, comprising:
logic configured to adjust an original service time of a first Wi-Fi Basic Service Set connection (“BSS”), out of a plurality of BSSs configured to be associated with a communication device, to an adjusted service time based on a time until beacon transmission or reception in any of the plurality of BSSs;
wherein at least one of the plurality of BSSs is supportive of a peer-to-peer connection.

2. The integrated circuit of claim 1, wherein if the beacon will be transmitted or received on the first BSS outside of the original service time, the logic is configured to adjust the original service time by increasing the original service time of the first BSS such that the beacon will be transmitted or received on the first BSS within the adjusted service time.

3. The integrated circuit of claim 1, wherein if the beacon will be transmitted or received on another BSS within the original service time, the logic is configured to adjust the original service time by decreasing the original service time of the first BSS such that the beacon will be transmitted or received on the another BSS outside of the adjusted service time.

4. The integrated circuit of claim 1, wherein the logic is configured to further adjust the original service time of the first BSS based on a difference between packet types, packet sizes, packet retransmissions, packet timestamps, acknowledgement counts, or received-frame sizes between the first BSS and another BSS.

5. The integrated circuit of claim 1, wherein the logic is configured to further adjust the original service time of the first BSS based on a difference between data rates between the first BSS and another BSS.

6. The integrated circuit of claim 1, wherein the logic is configured to further adjust the original service time of the first BSS based on a minimum BSS service time threshold, a maximum BSS service time threshold, or switching overhead between the first BSS and another BSS.

7. The integrated circuit of claim 1, wherein the adjusted service time=((sum of sizes packets in queue)/data rate of first BSS)+((buffering time)(number of the packets in the queue)).

8. The integrated circuit of claim 1, wherein the logic is configured to adjust the original service time while the first BSS is active.

9. A method comprising:
adjusting an original service time of a first Wi-Fi Basic Service Set connection (“BSS”), out of a plurality of BSSs configured to be associated with a communication device, to an adjusted service time based on a time until beacon transmission or reception in any of the plurality of BSSs, at least one of the plurality of BSSs supportive of a peer-to-peer connection.

10. The method of claim 9, further comprising, if the beacon will be transmitted or received on the first BSS outside of the original service time, adjusting the original service time by increasing the original service time of the first BSS such that the beacon will be transmitted or received on the first BSS within the adjusted service time.

11. The method of claim 9, further comprising, if the beacon will be transmitted or received on another BSS within the original service time, adjusting the original service time by decreasing the original service time of the first BSS such that the beacon will be transmitted or received on the another BSS outside of the adjusted service time.

12. The method of claim 9, further comprising adjusting the original service time of the first BSS based on a difference between packet types, packet sizes, packet retransmissions, packet timestamps, acknowledgement counts, or received-frame sizes between the first BSS and another BSS.

13. The method of claim 9, further comprising adjusting the original service time of the first BSS based on a difference between data rates between the first BSS and another BSS.

14. The method of claim 9, further comprising adjusting the original service time of the first BSS based on a minimum BSS service time threshold, a maximum BSS service time threshold, or switching overhead between the first BSS and another BSS.

15. The method of claim 9, wherein the adjusted service time=((sum of sizes packets in queue)/data rate of first BSS)+((buffering time)(number of the packets in the queue)).

16. The method of claim 9, further comprising adjusting the original service time while the first BSS is active.

17. A non-transitory machine-readable storage medium comprising executable instructions that, when executed, cause one or more processors to:
adjust an original service time of a first Wi-Fi Basic Service Set connection (“BSS”), out of a plurality of BSSs configured to be associated with a communication device, to an adjusted service time based on a time until beacon transmission or reception in any of the plurality of BSSs, at least one of the plurality of BSSs supportive of a peer-to-peer connection.

18. The medium of claim 17, wherein if the beacon will be transmitted or received on the first BSS outside of the original service time, the one or more processors are further caused to adjust the original service time by increasing the original service time of the first BSS such that the beacon will be transmitted or received on the first BSS within the adjusted service time.

19. The medium of claim 17, wherein if the beacon will be transmitted or received on another BSS within the original service time, the one or more processors are further caused to adjust the original service time by decreasing the original service time of the first BSS such that the beacon will be transmitted or received on the another BSS outside of the adjusted service time.

20. The medium of claim 17, wherein the one or more processors are further caused to adjust the original service time of the first BSS based on a difference between packet types, packet sizes, packet retransmissions, packet timestamps, acknowledgement counts, or received-frame sizes between the first BSS and another BSS.
